(19) United States
(12) Patent Application Publication
(10) Pub. No.: US 2026/0125506 A1
(43) Pub. Date: May 7, 2026

(54) LOW FREE POLYURETHANE PREPOLYMER COMPOSITION

(71) Applicant: URETHANE SYSTEMS USA LLC, Perth Amboy, NJ (US)

(72) Inventors: Ronald M. Emanuel, Morris, CT (US); Polina Ware, Southington, CT (US); Gerald King, Waterside (GB)

(73) Assignee: URETHANE SYSTEMS USA LLC, Perth Amboy, NJ (US)

(21) Appl. No.: 19/419,736

(22) Filed: Dec. 15, 2025

Related U.S. Application Data
(63) Continuation of application No. 17/642,733, now Pat. No. 12,522,687.
(60) Provisional application No. 62/899,476, filed on Sep. 12, 2019.

(51) Int. Cl. C08G 18/48; C08G 18/10; C08G 18/76; C08K 3/08; C08K 3/34; C08K 3/36; C09J 175/08

(52) U.S. Cl. CPC C08G 18/4808; C08G 18/10; C08G 18/7692; C09J 175/08; C08K 3/08; C08K 2003/0812; C08K 3/346; C08K 3/36

(57) ABSTRACT

A polyurethane prepolymer composition may include: (a) a polyurethane prepolymer comprising, as a reaction product, (a1) an excess of diisocyanate and (a2) a polyol; and (b) free diisocyanate monomer in a range of from more than 0 to less than 1.0 wt. %, based on total polyurethane prepolymer weight. The NCO content of the polyurethane prepolymer may be in a range of from 0.2 to 15 wt. %. The polyurethane prepolymer may include less than 75 wt. % of a 2:1 stoichiometric adduct of the diisocyanate and the polyol, based on the total polyurethane prepolymer weight. The polyol (a2) may include two polypropylene glycols with different molecular weights.

### CROSS-REFERENCE TO RELATED APPLICATIONS

The present application is a continuation of U.S. application Ser. No. 17/642,733, filed Mar. 14, 2022, and published as US 2022/0325028 A1, which was the national stage of international application PCT/US2020/050622, filed on Sep. 14, 2020, claiming the benefit of the filing date of U.S. Prov. Appl. No. 62/899,476, filed on Sep. 12, 2019. The content of each of these applications is incorporated by reference.

The present invention relates to a polyurethane prepolymer composition comprising more than 0 wt. % and less than 1.0 wt. % free diisocyanate monomer wherein the polyurethane prepolymer comprise less than 80 wt. % perfect prepolymers, curable compositions comprising these polyurethane prepolymer compositions and the use of these polyurethane prepolymer compositions as adhesives.

### BACKGROUND OF THE INVENTION

Isocyanate terminated polyurethane prepolymers are commonly used to produce polyurethane products like elastomers, foams, coatings, adhesives, sealants, and binders. However, the polyurethane prepolymer manufacturing process typically results in high residual concentrations of the polyisocyanate monomer used in the prepolymer synthesis. The residual polyisocyanate can lead to potential health and safety issues, and may also be detrimental to the performance and attributes of the end use product. For example, residual polyisocyanate can lead to undesired losses in open time, product instability, increased moisture sensitivity and decreased adhesion due to migration of these molecules to the interface. Polyurethane prepolymers that contain low levels of residual diisocyanate of less than 1.0 wt. %, preferably less than 0.1 wt. % based on the total amount of the prepolymer, can reduce health and safety risks and improve end product performance.

Since residual polyisocyanate can pose significant health and safety risks as well as reductions in product performance, a number of products and processes have been introduced that offer reduced residual polyisocyanate levels.

JP 08-176252 discloses reacting MDI with straight chain molecule with MW 250-4,000 and two active hydrogens at an equivalent ratio (NCO:OH) of 2.5-10:1. Free MDI is vacuum distilled to 1 wt. % or less. The examples show polytetramethylene glycol (PTMEG) and ethylene glycol adipate.

U.S. Pat. No. 4,786,703 discloses a process for producing a reaction product comprising a TDI prepolymer, wherein at least about 90% of such prepolymer consists of a prepolymer of two moles TDI per mol long chain diol and the level of unreacted TDI is less than about 0.15%. This document teaches the benefits of high amount of prefect prepolymers of more than 90 wt. %.

U.S. Pat. No. 4,888,442 discloses a process for reducing the free monomer content of a polyisocyanate adduct by treating the adduct with 2-30 wt. % inert solvent in an agitated thin-layer evaporator under conditions sufficient to reduce the free monomer content of the polyisocyanate adduct mixture below that level which is obtainable in the absence of a solvent. There are no examples showing the use of MDI as a suitable diisocyanate to prepare the polyisocyanate adduct.

U.S. Pat. No. 4,892,920 discloses a process for producing cyclohexanediisocyanate (CHDI) based prepolymers free of unreacted CHDI and essentially free of oligomeric CHDI by-products.

U.S. Pat. No. 5,202,001 discloses preparing polyurethane prepolymers having low levels of residual organic diisocyanate. The examples shows prepolymers made from toluene diisocyanate (TDI), isophorone diisocyanate (IPDI) and methylene-bis[(4-cyclohexyl)-diisocyanate] (CHDI).

U.S. Pat. No. 5,703,193 discloses a process for reducing the amount of residual organic diisocyanate monomer in a polyurethane prepolymer reaction product by distilling in the presence of an inert solvent blend, one with boiling point above the monomer and one with boiling point below. Comparative examples show the removal of MDI monomer from a PTMEG 1000/MDI prepolymer reaction product.

U.S. Pat. No. 6,133,415 discloses countercurrent extraction method for making polyurethane prepolymers. The examples show MDI/PTMEG prepolymers processed to give low free MDI.

U.S. Pat. No. 6,174,984 discloses a prepolymer of at least one diisocyanate and at least one polyether polyol selected from the group consisting of a homopolymer of ethylene oxide, a homopolymer of propylene oxide, and a copolymer of ethylene oxide and propylene oxide, wherein free diisocyanate has been reduced to a level of less than 1% of the prepolymer.

EP 0 827 995 A discloses hot melt adhesives comprising a polyisocyanate prepolymer prepared by reacting a polyisocyanate with a functionality of at least 2 with a polyol with a functionality of at least 2, the reaction product comprising at least 90 wt. % “perfect” prepolymer and less than 2 wt. % unreacted isocyanate monomer and the prepolymer having a free NCO functionality ranging from 0.2 to 8 wt. %. This document teaches the benefits of high amount of prefect prepolymers of more than 90 wt. %.

U.S. Pat. No. 6,866,743 discloses prepolymer composition based on MDI or TDI consisting essentially of at least 80 wt. % perfect prepolymers and less than 2 wt. % free MDI monomer suitable for use in non-structural polyurethane adhesive compositions.

U.S. Pat. No. 6,884,904 discloses an MDI/polypropylene polyether prepolymer composition consisting essentially of at least 80 wt. % perfect prepolymers and less than 2 wt. % free MDI monomer suitable for use in polyurethane adhesive compositions. Polyurethane prepolymer compositions comprising less than 80 wt. % perfect prepolymer and less than 1.0 wt. % residual diisocyanate monomer are not disclosed.

U.S. Pat. No. 6,943,202 discloses polyurethane prepolymer with NCO content of at least 70% of the theoretical NCO content for a pure ABA structure and preferably at least 80% of the theoretical NCO content for a pure ABA structure.

WO 01/040340 A1 discloses polyurethane compositions having a low level of monomeric diisocyanates can be prepared in a two-stage process wherein a diol component having a molecular weight of less than 2000 and a monomeric diisocyanate having a molecular weight of less than 500 are reacted in a first step. A molar ratio of MDI:polyol of 5:1 to 10:1 is preferred, as it as it favors the formation of a final prepolymer (after removal of solvent and free MDI monomer) with NCO content at least about 80% of the theoretical NCO content for a pure ABA structure. The resulting low-monomer macromolecular diisocyanate is reacted in a second step with a polyol to form a reactive prepolymer having isocyanate end groups. Such polyurethane compositions are said in this reference to be useful as binders for reactive one- or two-component adhesive/sealant materials, which may be solvent containing, and also, provided the polyols are chosen appropriately, for preparing reactive hot melts.

US 2004/259968 A1 discloses a composition comprising at least one reaction product of polyols with a stoichiometric excess of mixtures of asymmetrical polyisocyanates having a molecular weight below 500 and an NCO functionality from 1.75 to 2.5 and high molecular weight polyisocyanates. In a non-inventive comparison example, a prepolymer based on 4,4′-MDI and PPG-750 in a ratio of 5:1 with an residual amount of monomeric MDI of <0.1% is disclosed.

US 2007/060731 A1 discloses, that the formation of oligomeric polyurethanes is undesirable, when defined ABA structures of isocyanate and polyol are to be built, as such defined structures have a positive effect on the property profile of e.g. compact elastomers such as thermoplastic polyurethanes or pourable elastomers. Asymmetrical diisocyanates such as 2,4′-MDI is reacted with PPG-450 to provide prepolymers with diurethane, of more than 80 area-%, determined via GPC.

In view of the prior art, it becomes evident that polyurethane prepolymers with high amount of “perfect” prepolymers and low amounts of oligomers were preferred.

It was a long felt desire to provide polyurethane prepolymers with low amounts of free diisocyanate monomers, which nevertheless provide cured polyurethanes with comparable or even better physical properties such as tear strength or adhesives characteristics such as high shear strength as those polyurethane prepolymers with high NCO functionality.

It has been now surprisingly found, in contrast to the long standing teaching in the prior art, that polyurethane prepolymers with low amounts of residual free diisocyanate monomer of more than 0 wt. % and less than 1.0 wt. %, based on the total weight of polyurethane prepolymer and less than 80 wt. % perfect prepolymer show desired performance advantages over polyurethane prepolymers with low amounts of residual diisocyanate monomers and 80 wt. % or more perfect prepolymer.

### SUMMARY OF THE INVENTION

The present invention is directed to an isocyanate terminated polyurethane prepolymer composition comprising a polyurethane prepolymer which is the reaction product of the reaction of diisocyanate with at least one polyol, and more than 0 wt. % and less than 1.0 wt. %, preferably less than 0.5 wt. % and more preferably less than 0.1 wt. % free diisocyanate monomer based on the total weight of the polyurethane prepolymer, wherein the polyurethane prepolymer comprises less than 80 wt. % perfect prepolymer, based on the total weight of the polyurethane prepolymer.

### DETAILED DESCRIPTION OF THE INVENTION

This invention relates to a polyurethane prepolymer composition based on the reaction of an diisocyanate and a polyol, having a low level of residual diisocyanate monomer and a high oligomer content.

The polyurethane prepolymer composition is the product resulting from the reaction of a polyol containing “n” (at least 2) OH groups and an diisocyanate. The polyurethane prepolymer reaction product comprises oligomers and “perfect” prepolymers. The requisite high oligomer content of the prepolymer composition is >20 wt. % or, reciprocally, it can expressed in terms of its “perfect” prepolymer content which should be <80 wt. %.

A “perfect” prepolymer of the present invention in terms of stoichiometry is a prepolymer of n diisocyanate molecules and one polyol molecule. The stoichiometric proportions for the diisocyanate and polyol in the reaction products are 2:1 in the case of diols and 3:1 for triols. The perfect prepolymer is essentially an adduct containing only one molecule of the polyol in each prepolymer molecule. The invention requires that the polyurethane prepolymer composition (1) comprises less than 80 wt. % of a stoichiometric “perfect” prepolymer based on the total weight of polyurethane prepolymer and (2) comprises more than 0 wt. % and less than 1.0 wt. % unreacted, and thus free, diisocyanate monomer. In a preferred embodiment, the invention requires that this diisocyanate prepolymer reaction product (1) comprises more than 30 wt. % and less than 80 wt. % of a stoichiometric “perfect” prepolymer and (2) contains more than 0 wt. % and less than 0.1 wt. % unreacted diisocyanate monomer.

The polyurethane prepolymers of the present invention are controlled structure polyurethane prepolymers comprising the reaction product of a diisocyanate (A) having a functionality (f) of at least two, with a polyol (B) of functionality (f) ≥2. The polyurethane prepolymer reaction product contains free prepolymer NCO functionality ranging from 0.2 to 15 wt. %, preferably, 0.5 to 8 wt. % and more preferably 5 to 7 wt. %.

The polyurethane prepolymer compositions of the present invention contain free prepolymer NCO ranging from 0.2 to 15 wt. %, preferably 0.5 to 8 wt. %, more preferably 5 to 7 wt. % and more than 0 wt. % and less than 1.0 wt. % unreacted diisocyanate monomer, preferably less than 0.5 wt. %, and more preferably less than 0.1 wt. %.

In a preferred embodiment of the present invention, the polyurethane prepolymer comprises at least 30 wt. % “perfect prepolymer” and less than 80 wt. % “perfect prepolymer, preferably less than 75 wt. % “perfect” prepolymers, more preferably less than 70 wt. %, even more preferably less than 65 wt. % of the prepolymer reaction product obtained by the reaction of the diisocyanate with the polyol, or reciprocally at least 20 wt. % oligomers, preferably at least 25 wt. % oligomers, more preferably at least 30 wt. % oligomers and even more preferably at least 35 wt. % oligomers.

A “perfect” prepolymer, or adduct, is the perfect end capping product of a polyol (B) with n diisocyanate molecules (A), where n=the functionality (f) of B. For a difunctional B, the perfect prepolymer is represented as A:B:A.

Oligomers, for a difunctional B (n=2), are any species with a composition greater than the perfect 2:1 molecular ratio (A:B:A), for example 3:2 (A:B:A:B:A) or 4:3 (A:B:A:B:A:B:A). For a trifunctional B (n=3), the perfect prepolymer is represented as B: 3A. Oligomers in this instance are any species with a composition greater than the perfect 3:1 molecular ratio.

### Diisocyanate

The diisocyanate of the present invention is not particularly limited. Suitable diisocyanates of the present invention include aliphatic diisocyanates, cycloaliphatic diisocyanates, polycyclic diisocyanates, aromatic diisocyanates and aliphatic-aromatic diisocyanates.

In a preferred embodiment, the diisocyanate of the present invention is methylene diphenyl diisocyanate (MDI), para-phenylene diisocyanate (PPDI), naphthalene diisocyanate (NDI), hexamethylene diisocyanates (HDI), cyclohexyl diisocyanates (CHDI), isophorone diisocyanate (IPDI), or toluene diisocyanate (TDI).

In a more preferred embodiment, the polyurethane prepolymer is prepared using 4,4′-methylene-bis-(phenyl isocyanate) (4,4′-MDI).

### Polyol

The present invention is not limited by the use of a particular polyol and more than one may be used. A polyol suitable for the present invention may be selected from any polyol known in the art.

Polyols include compounds having more than one hydroxyl groups. Thus, polyols suitable for the present invention comprise diols, triols, and/or higher average hydroxyl functionality. The average hydroxyl functionality can range from 2 to 8, preferably 2 to 3 and more preferably from 2 to 2.5. The formation of such polyols is well known in the art.

In many embodiments, diols are preferred over triols or polyols with higher hydroxyl functionality.

In some embodiments of the present invention, the polyol comprises at least one polyester polyol, at least one polyether polyol, at least one polycaprolactone polyol, at least one polycarbonate polyol, or combinations thereof.

Preferred polyols are polypropylene oxide based polyether polyols, also known as polypropylene glycols (PPG), which include, but are not limited to, polypropylene polyether polyols with functionality of two or greater, average equivalent weight between 100 and 8,000. Also included are ethylene oxide capped PPGs and low monol containing PPGs.

Additional polyols which may be used include alkylene diols such as diethylene glycol (DEG), other di- or multi-functional alkylene ether polyols such as poly(tetramethylene ether) glycol (PTMEG) and polyethylene oxide, polyester polyols, polyester polyols from polycaprolactones and hydroxyl terminated polybutadienes.

The above polyether and polyester polyols are commonly used for producing polyurethane prepolymers. The polyol can be blended such that the at least one polyol, either the single polyol or a blend, used in making the prepolymer has an average molecular weight (Mw) ranging from about 50 to 16,000 g/mol, preferably 250 to 4,000 g/mol and preferably from 500 to 1,100 g/mol. In another preferred embodiment, the at least one polyol comprises two polypropylene glycols with different molecular weight. Average molecular weight can be determined with GPC.

### Process for Preparing Polyurethane Prepolymer

Polyurethane prepolymer according to this present invention is prepared by the reaction of an excess of diisocyanate with at least one polyol.

In preferred embodiments, the polyurethane prepolymer of the present invention is prepared by reaction of at least one polyol with MDI.

In some embodiments, the polyurethane prepolymers are prepared by reaction of at least one diisocyanate with polypropylene glycol.

A polyurethane prepolymer of the present invention can be prepared under the conditions of heating a reaction mixture of the polyol and the diisocyanate at 50° C. to 150° C. for 10 min to 24 h, preferably 60° C. to 100° C. for 2 h to 6 h.

Methods for synthesizing polyurethane prepolymers are generally known in the art. Generally, the polyurethane prepolymers of the present invention are made using standard reaction processes and conditions as known in the art for the production of polyurethane prepolymers generally.

The polyurethane prepolymer of the present invention is typically prepared using an excess of diisocyanate monomer resulting in a polyurethane prepolymer composition comprising unreacted monomer, e.g., unreacted or “free” diisocyanate. Levels of 20 wt. % or more of free diisocyanate monomer based on the polyurethane prepolymer composition, may be encountered.

The polyurethane prepolymer of the present invention is a “low free monomer” polyurethane prepolymer (also known as “low free” or “LF” or “low isocyanate”=“LNCO”).

Understood by one of ordinary skill in the art to have lower amounts of “free” monomer isocyanate groups than conventional polyurethane prepolymers, i.e. the polyurethane prepolymer compositions of the present invention have less than 1.0 wt. % free diisocyanate monomers based on the total weight of the polyurethane prepolymer.

The unreacted diisocyanate monomer in the prepolymer reaction product is removed to a concentration of more than 0 wt. % and less than 1 wt. %, preferably less than 0.5 wt. %, most preferably less than 0.1 wt. %. Polyurethane prepolymer without any residual free diisocyanate monomer would have an unfavored high viscosity.

Any process suitable in reducing the amount of free diisocyanate monomer in the polyurethane prepolymer composition to the low levels of the present invention may be employed. A variety of methods is known for reducing the residual isocyanate content of polyisocyanate monomers to a minimum such as wiped film evaporation, solvent aided distillation/co-distillation, molecular sieves, and solvent extraction. Distillation under reduced pressure is preferred, in particular thin film or agitated film evaporation under vacuum.

### Curable Polyurethane Prepolymer Composition

The invention further relates to a curable polyurethane prepolymer composition, comprising the polyurethane prepolymer composition of the present invention and at least one curative.

### Curative

Suitable curatives for the curable polyurethane prepolymer composition of the present invention include diamines, polyols, or blends thereof.

Examples of diamines include both aromatic and aliphatic diamines, primary and secondary amine terminated polyether polyols, and difunctional, trifunctional, and polymeric amines.

Examples of polyols include polyester or polyether polyols, which can be diols, triols and tetrols, having primary, secondary and/or tertiary alcohol groups. These polyols may be mixed with the diamines.

The ratio of the prepolymer to the curative is typically in the range of from 0.5:1 to 1.5:1, preferably from 0.7:1 to 1.2:1, and more preferably from 1.1:1 to 0.90:1.

### Additives

The curable polyurethane prepolymer composition of the present invention optionally comprises further additives, such as catalysts; thickening agents; tackifying resins, for example abietic acid, abietic ester, terpene resins, terpene phenol resins or hydrocarbonaceous resins; fillers, for example silicates, talcum, calcium carbonates, clays or carbon black; plastizicers, for example phthalates: thixotropiczing agents, for example bentones, pyrogenic silicas, urea derivatives, fibrillated or pulped short fibers; color agents, for example color pastes and pigments or drying agents.

Optional catalysts include tertiary amine catalysts and suitable organometallic catalysts, such as those derived from tin, zirconium, and bismuth.

### Adhesive

The present invention is also related to a method for adhesively joining or sealing two substrates, comprising the steps of:
(1) applying onto a substrate the curable polyurethane prepolymer composition of the present invention, and
(2) contacting the curable polyurethane prepolymer composition applied on the substrate to a second substrate such that a bond is formed.

In one embodiment, the polyurethane adhesive composition used in the method of the present invention comprises the above-described polyurethane prepolymer reaction product which can be prepared by reacting a diisocyanate, preferably 4,4′-MDI with a polypropylene polyether polyol with an average molecular weight of 500 to 1,100 g/mol.

Substrates that may be bonded with the adhesive include cold rolled steel, aluminum, fiberglass reinforced polyester (FRP), sheet molding compound (SMC), plastics, wood, and glass.

Thus, the present invention relates further to the use of the curable polyurethane prepolymer composition of the present invention as an adhesive. In a preferred embodiment, a polyurethane prepolymer composition comprising a polyurethane prepolymer obtained by the reaction of 4,4′-MDI with at least one polypropylene glycol, and comprising more than 0 wt. % and less than 1.0 wt. %, preferably less than 0.5 wt. % and more preferably less than 0.1 wt. % free 4,4′-MDI monomer based on the total weight of the polyurethane prepolymer, wherein the polyurethane prepolymer comprises less than 80 wt. % perfect prepolymers.

The present invention encompasses also the use of the curable polyurethane prepolymer composition of the present invention as an adhesive at room temperature, as a holt-melt adhesive and as a one component foam (OCF).

The use of a polyurethane prepolymer composition of the present invention in an adhesive composition provides adhesives showing improved shear strength after 1 or 7 days curing at room temperature compared to adhesive compositions based on non-inventive polyurethane prepolymers with low amounts of oligomers or non-inventive conventional polyurethane prepolymers with high amounts of residual diisocyanate monomers, and the health and safety benefits associated with lower levels of volatile diisocyanate monomer of less than 1.0 wt. %.

### EXAMPLES

The following materials were used in the Examples:

| | |
|---|---|
| Mondur ® M | diphenylmethane 4,4′-diisocyanate; MDI; CAS |
| | No.: 101-68-8; (Commercially available from |
| | Covestro) |
| Lupranol ® 1200 | polypropylene glycol; PPG-500; Mw = 500 g/mol; |
| | CAS No.: 25322-69-4; (Commercially available |
| | from BASF) |
| Lupranol ® 1100/1 | polypropylene glycol; PPG-1100; Mw = |
| | 1100 g/mol; CAS No.: 25322-69-4; |
| | (Commercially available from BASF) |
| Tri(propylene)glycol | tripropylene glycol; TPG; CAS No.: 24800-44-0; |
| | (Commercially available from Sigma Aldrich) |

### Adhesive Experiments

| | |
|---|---|
| Quadrol ® polyol | (Ethylenedinitrilo)tetra-2-propanol; CAS No.: |
| | 102-60-3; Commercially available from Sigma |
| | Aldrich |
| Microtuff ® 325F | talc; Commercially available from Barretts |
| | Minerals |
| Arcol ® Polyol PPG-2000 | polypropylene glycol; PPG-2000; |
| | Mw = 2,000 g/mol; Commercially available from |
| | Covestro |
| Cab-o-sil ® TS 720 | fumed silica; Commercially available from Cabot |
| Aluminum Powder, 325 Mesh, Grade 101 | Commercially available from Toyal America |
| Microbeads (10 mm) | Commercially available from Cataphote |
| Aluminum coupon | Commercially available from AlKemix |
| Methyl ethyl ketone | (MEK) Commercially available from Sigma |
| | Aldrich |
| Chemlok ® 218 | One-coat adhesive (Commercially available from |
| | Lord) |
| 1,4-butanediol | (BDO) Commercially available from |
| | Sigma Aldrich |
| Hydroquinone bis(2-hydroxyethyl) ether | (HQEE) Commercially available from |
| | Sigma Aldrich |

### Example 1 (Inventive)

6046 g of 4,4′-Methylene diisocyanate (4,4′-MDI) were added to a reactor and heated to 50° C. 2896 g of PPG-500 and 1646 g of PPG-1100 was then added. The reaction temperature was held at 80° C. for 4 hours. Excess residual 4,4′-MDI monomer was removed by thin-film distillation under reduced pressure from the reaction product to a level of less than 0.1 wt. % residual 4,4′-MDI, and total % NCO content of 6.05 wt. %.

### Example 2 (Inventive)

2880 g of 4,4′-MDI were added to a reactor and heated to 50° C. 603 g of PPG-500 and 1017 g PPG-1100 was then added. The reaction temperature was held at 80° C. for 4 hours. Excess residual 4,4′-MDI monomer was removed by thin-film distillation under reduced pressure from the reaction product to a level of less than 0.1 wt. % residual 4,4′-MDI, and total % NCO content of 6.10 wt. %.

### Example 3 (Comparative)

4182 g of 4,4′-MDI were added to a reactor and heated to 50° C. 443 g of PPG-500 and 1500 g PPG-1100 was then added. The reaction temperature was held at 80° C. for 4 hours. Excess residual 4,4′-MDI monomer was removed by thin-film distillation under reduced pressure from the reaction product to a level of less than 0.1 wt. % residual 4,4′-MDI, and total % NCO content of 5.87 wt. %.

### Example 4 (Comparative)

1584 g of 4,4′-MDI were added to a reactor and heated to 50° C. 900 g of PPG-500 and 1516 g of PPG-1100 was then added. The reaction temperature was held at 80° C. for 4 hours. The reaction product had a % NCO content of 5.90 wt. %. The residual 4,4′-MDI monomer content is >5 wt. %.

Table 1 presents the % NCO, residual free MDI and oligomer content for the MDI/PPG polymers of Examples 1-4.

TABLE 1
Characteristics of the prepolymer compositions

| | | Measured | % of | residual | Oligomer |
|---|---|---|---|---|---|
| | | % NCO | theoretical | MDI | content |
| Example | Polyol | [wt. %] | NCO | [wt. %] | [wt. %] |
| 1* | PPG-500/PPG-1100 | 6.05 | 76 | <0.1 | 53.8 |
| 2* | PPG-500/PPG-1100 | 6.10 | 86 | <0.1 | 28.5 |
| 3 | PPG-500/PPG-1100 | 5.87 | 92 | <0.1 | 18.2 |
| 4 | PPG-500/PPG-1100 | 5.90 | N/A | >5 | >50 |

*Inventive examples

The inventive examples 1 and 2 show a residual 4,4′-MDI content of less than 0.1 wt. % based on the total weight of the polyurethane prepolymer, and a oligomer content of more than 20 wt. %. Thus, the amount of perfect prepolymer is less than 80 wt. % in the inventive examples 1 and 2.

### Example 5

The prepolymer compositions of Examples 1-4 were evaluated in the following structural adhesive composition by room temperature curing on an aluminum coupon:

TABLE 2
Components of the adhesive composition

| Part A | wt. % | Part B | wt. % |
|---|---|---|---|
| Prepolymer (Ex. 1-4) | 60 | Arcol ® PPG-2000 | 16.7 |
| Aluminum Powder | 38 | Quadrol ® | 33.3 |
| Cab-o-sil ® TS720 | 2 | Microtuff ® 325F | 27 |
| | | Cab-o-sil ® TS720 | 1 |
| | | Aluminum Powder | 22 |

The adhesive composition was prepared by mixing Part A and Part B in an NCO:OH ratio of 1:0.9 while adding 1 wt. % of microbeads. The substrates were prepared according to the steps of the following substrate preparation process:

### (1) Abrasion

The aluminum coupon was partly abraded with 20/40 crushed glass @ 80 psi Nozzle to part distance 6″. The expected profile on the aluminum coupon was 2 to 3 mm.

### (2) Solvent Wash

The surface was washed with acetone followed by air dry.

The adhesive composition was then applied to one side of a 2.54×12.7 cm aluminum coupon to cover at least 3.23 cm² of area then mated with a second substrate coupon to give a total lapshear overlap of 3.23 cm². Samples were cured at room temperature and 50% humidity. Samples were prepared and tested according to ASTM D10002-10 (Standard Test Method for Apparent Shear Strength of Single-Lap-Joint Adhesively Bonded Metal Specimens by Tension Loading (Metal-to-Metal)) after 1 day and 7 days. All testing done at room temperature.

TABLE 3
Lap Shear Strength data without bonding agent

| | | Shear strength [MPa] | Shear strength [MPa] |
|---|---|---|---|
| Prepolymer | Cure** | after 1 day | after 7 days |
| Ex 1* | RT | 12.3 | 13.0 |
| Ex 2* | RT | 12.0 | 11.8 |
| Ex 3 | RT | 9.0 | 9.1 |
| Ex 4 | RT | 10.5 | 10.6 |

*Inventive examples; **50% humidity

The results in Table 3 show that adhesive compositions based on the inventive polyurethane prepolymer examples 1 and 2 have higher shear strength after 1 and 7 days of cure compared to adhesive compositions based on non-inventive prepolymers with low amounts of oligomers (Example 3) or non-inventive conventional high amounts of free diisocyanate monomer (Example 4).

### Example 6

The adhesive testing procedure was repeated as described in Example 5 with the exception that, as a third step in the substrate preparation process, a bonding agent was applied on the abraded and washed surface of the aluminum coupon before the adhesive composition was applied, according as followed:

### (3) Bonding Agent

A bonding agent consisting of a 50:50 blend of methyl ethyl ketone (MEK) & Chemlok® 218 adhesive was prepared. The aluminum coupons were dipped into the bonding agent and hung vertically to dry.

The results of the shear strength tests are shown in table 4.

TABLE 4
Lap Shear Strength data with bonding agent

| | | Shear strength [MPa] | Shear strength [MPa] |
|---|---|---|---|
| Prepolymer | Cure** | after 1 day | after 7 days |
| Ex 1* | RT | 11.4 | 12.8 |
| Ex 2* | RT | 11.6 | 12.0 |
| Ex 3 | RT | 10.5 | 11.2 |
| Ex 4 | RT | 11.2 | 11.9 |

*Inventive examples; **50% humidity

The data in Table 4 shows that comparable shear strength between the adhesive composition based on inventive prepolymer compositions and non-inventive prepolymer compositions can only be achieved, by using and additional, unfavored, process step of applying a binding agent.

### Example 7

Cast elastomers were prepared by conventional techniques using the prepolymers of Examples 1 to 4. The polyurethane prepolymer compositions were cured with 1,4 butane diol (BDO) or hydroquinone bis(2-hydroxyethyl) ether (HQEE) at 98% stoichiometry, and afterwards post-cured at 115° C. for 16 hours. Physical properties were obtained using the following ASTM test methods: Hardness (ASTM D2240); Split Tear (ASTM D-470); Trouser Tear (ASTM D-1938); Die-C Tear (ASTM D-624). Tables 5 and 6 show the data.

TABLE 5
Physical properties of cast elastomers based on polyurethane
prepolymer compositions cured with HQEE

| Prepolymer | Hardness | Split Tear | Trouser Tear | Die-C Tear |
|---|---|---|---|---|
| Example | [Shore A/D] | [kN/m] | [kN/m] | [kN/m] |
| 1* | 70D | 22.8 | 73.9 | 118.3 |
| 2* | 96A | 19.8 | 45.1 | 97.3 |
| 3 | 95A | 15.8 | 29.5 | 81.7 |
| 4 | 94A | 22.2 | 43.7 | 76.1 |

*inventive

TABLE 6
Physical properties of cast elastomers based on polyurethane
prepolymer compositions cured with BDO

| Prepolymer | Hardness | Split Tear | Trouser Tear | Die-C Tear |
|---|---|---|---|---|
| Example | [Shore A/D] | [kN/m] | [kN/m] | [kN/m] |
| 1* | 97A/60D | 15.1 | 63.3 | 48.4 |
| 2* | 80A | 6.0 | 19.1 | 26.3 |
| 3 | 62A | 3.8 | 7.5 | 25.4 |
| 4 | 75A | 6.2 | 12.9 | 32.3 |

*inventive

The low monomeric, high oligomer prepolymers of inventive Examples 1 and 2 show superior split tear, trouser tier and Die-C tear strength in comparison to non-inventive Examples 3 and 4.

1. A polyurethane prepolymer composition, comprising:
(a) a polyurethane prepolymer comprising, as a reaction product, (a1) an excess of diisocyanate and (a2) a polyol; and
(b) free diisocyanate monomer in a range of from more than 0 to less than 1.0 wt. %, based on total polyurethane prepolymer weight,
wherein the polyurethane prepolymer (a) has an NCO content in a range of from 0.2 to 15 wt. %,
wherein the polyurethane prepolymer (a) comprises less than 75 wt. % of a 2:1 stoichiometric adduct of the diisocyanate (a1) and the polyol (a2), based on the total polyurethane prepolymer weight,
wherein the polyol (a2) comprises (a2a) a first polypropylene glycol and (a2b) a second polypropylene glycol,
wherein the first polypropylene glycol (a2a) has a different molecular weight from the second polypropylene glycol (a2b).

2. The polyurethane prepolymer composition of claim 1, wherein the first polypropylene glycol (a2a) has a weight average molecular weight Mw in a range of from 200 to 800 g/mol, and
wherein the second polypropylene glycol (a2a) has a weight average molecular weight Mw of 800 to 2,000 g/mol.

3. The polyurethane prepolymer composition of claim 1, wherein the diisocyanate (a1) comprises methylene diphenyl diisocyanate, para-phenylene diisocyanate, naphthalene diisocyanate, hexamethylene diisocyanate, cyclohexyl diisocyanate, isophorone diisocyanate, toluene diisocyanate.

4. The polyurethane prepolymer composition of claim 1, wherein the diisocyanate (a1) comprises 4,4′-methylene diphenyl diisocyanate.

5. The polyurethane prepolymer composition of claim 1, wherein the first polypropylene glycol (a2a) has a weight average molecular weight Mw in a range of from 200 to 600 g/mol.

6. The polyurethane prepolymer composition of claim 1, wherein the polyurethane prepolymer (a) comprises the 2:1 stoichiometric adduct in a range of from more than 30 to less than 75 wt. %.

7. The polyurethane prepolymer composition of claim 1, comprising the free diisocyanate monomer (b) in a range of from more than 0 to less than 0.1 wt. %, based on the total polyurethane prepolymer weight.

8. A curable polyurethane prepolymer composition, comprising:
the polyurethane prepolymer composition of claim 1; and
a curative,
wherein the curative is a diamine, a polyol, or a blend thereof.

9. A method for adhesively joining or sealing two substrates, the method comprising:
(1) applying onto a substrate the curable polyurethane prepolymer composition of claim 5; and
(2) contacting the curable polyurethane prepolymer composition applied on the substrate to a second substrate such that a bond is formed.

10. An adhesive, comprising:
the curable polyurethane prepolymer composition of claim 8.

11. The polyurethane prepolymer composition of claim 1, comprising the free diisocyanate monomer (b) in a range of from more than 0 to less than 0.5 wt. %.

12. The polyurethane prepolymer composition of claim 1, wherein the NCO content of the polyurethane prepolymer (a) is in a range of from 0.2 to 8 wt. %.

13. The polyurethane prepolymer composition of claim 1, wherein the polyol (a2) has a weight average molecular weight (Mw), determined with gel permeation chromatography (GPC), in a range of from 250 to 4,000 g/mol.

14. The polyurethane prepolymer composition according to claim 1, wherein the weight average molecular weight Mw of the first polypropylene glycol (a2a) is in a range of from 400 to 600 g/mol.

15. A curable polyurethane prepolymer composition, comprising:
the polyurethane prepolymer composition of claim 1; and
1,4-butanediol and/or hydroquinone bis(2-hydroxyethyl) ether.

16. The polyurethane prepolymer composition of claim 1, wherein the polyurethane prepolymer (a) comprises the 2:1 stoichiometric adduct in a range of from more than 30 to 70 wt. %, based on total prepolymer composition weight.

17. The polyurethane prepolymer composition of claim 1, wherein the polyurethane prepolymer (a) comprises the 2:1 stoichiometric adduct in a range of from 35 to 65 wt. %, based on total prepolymer composition weight.

18. The polyurethane prepolymer composition of claim 1, wherein the first polypropylene glycol (a2a) comprises PPG-500.

19. The polyurethane prepolymer composition of claim 1, wherein the first polypropylene glycol (a2a) comprises PPG-500, and
wherein the second polypropylene glycol (a2b) comprises PPG-1100.
